(19) United States
(12) Patent Application Publication
(10) Pub. No.: US 2026/0279321 A1
(43) Pub. Date: Sep. 17, 2026

(54) ACOUSTIC PANEL

(71) Applicant: Inter IKEA Systems B.V., Delft (NL)

(72) Inventor: Daniel STJERNQVIST, Älmhult (SE)

(21) Appl. No.: 19/168,515

(22) PCT Filed: Mar. 28, 2024
(86) PCT No.: PCT/EP2024/058440

§ 371 Date: Sep. 24, 2025

(30) Foreign Application Priority Data
Mar. 31, 2023 (SE) 2350375-8

(51) Int. Cl. G10K 11/162; E04B 1/86

(52) U.S. Cl. CPC G10K 11/162; E04B 1/86

(57) ABSTRACT

An acoustic panel, including a sound absorbing material including lignocellulosic fibres providing sound absorbing properties to the sound absorbing material, and a binder binding the lignocellulosic fibres together. The binder is a bi-component binder fibre. A method for manufacturing the acoustic panel including providing a first sheet of the sound absorbing material and the binder, shaping the sound absorbing material into a piece of sound absorbing material having a desired shape and size, and optionally covering, at least partly, the sound absorbing material with a cover material.

### FIELD OF THE INVENTION

The present invention relates to an acoustic panel. Further the invention relates to manufacturing of said acoustic panel and a sound absorbing material provided in said acoustic panel.

### BACKGROUND

Sound absorbing or sound isolating materials are commonly used in rooms and/or furniture, such as room dividers or doors, to reduce or isolate noise in the environment. Such materials may be used to form so called acoustic panels.

However, several sound absorbing materials are foam like materials formed from non-sustainable materials, which are difficult to recycle and are not environmentally friendly.

Wood wool has been used as the sound absorbing material in acoustic panels. U.S. Pat. No. 9,691,370 discloses a panel having an acoustical absorbing layer formed of wood wool consisting of long strands of a wood fibre mixed with a cement-type adhesive. Even though wood fibres are sustainable, the material is difficult to recycle due to the cement-type adhesive.

Hence, there is a need to provide an improved acoustic panel, which is more environmentally friendly.

### SUMMARY

Consequently, the present invention seeks to mitigate, alleviate, eliminate or circumvent one or more of the above identified deficiencies in the art and disadvantages singly or in any combination by providing, according to a first aspect, an acoustic panel, comprising a sound absorbing material. The sound absorbing material comprises lignocellulosic fibres providing sound absorbing properties to the sound absorbing material, and a binder binding the lignocellulosic fibres together. The binder is a bi-component binder fibre. This panel is advantageous in that it is both sound absorbing, light weight, and flexible. In addition, the sound absorbing material is more environmentally friendly than for instance known sound absorbing foam like materials. It is also easy to manufacture and cheap due to abundancy of the lignocellulosic fibres. The flexibility of the panel makes it easy to shape the sound absorbing material into a desired predetermined shape. Also, the flexibility makes the sound absorbing panel bendable, allowing it to be used for curved applications, which is not possible for stiffer, rigid materials.

In a first embodiment, the lignocellulosic fibres are wood fibres. This is beneficial since wood fibres are abundant and thus cheap. In addition they are light weight and sustainable. Hence, the wood fibres contribute to the panel being more environmentally friendly than for instance acoustic panels comprising foam like materials.

In one embodiment, the majority of the wood fibres may have a length up to 50 mm. The length impacts how soft or rigid the fibre is experienced and how durable the fibre is. This in turn affects the sound absorbing properties of the sound absorbing material. The length of up to 50 mm results in a material with satisfying softness and durability of the fibre, and thus an effective sound absorbing properties.

In another embodiment, the lignocellulosic fibres have a length between 1 and 25 mm. This length is preferred since the length may have impact on how soft or rigid the fibre is experienced and how durable the fibre is. This in turn affects the sound absorbing properties of the sound absorbing material. The preferred length of 1 to 25 mm results in a material with satisfying softness and durability of the fibre, and thus the most effective sound absorbing properties.

In a further embodiment, the binder is present at a concentration between 1 to 30 wt %, preferably between 2 to 20 wt %, most preferred 3 to 15 wt %, and/or wherein the binder fibres have a length in the range of 3-24 mm, preferably 3-12 mm, or even 5-8 mm, and/or wherein the binder fibres have a thickness of 1-3 dtex, preferably 1-2.2 dtex. This is advantageous in that the binder is present at a low concentration, thus providing an environmentally friendly material, which is easy to recycle. The low concentration of the binder allows for a sound absorbing material comprising less plastic elements, which is therefore more environmentally friendly and easier to recycle. The binder fibre length and/or the binder fibre thickness provides satisfying bonding between the lignocellulosic fibres and the binder; and thus results in a texture of the material giving advantageous sound absorbing properties.

In one embodiment, the bi-component binder fibre comprises polypropylene (PP), polyethylene (PE), polyethylene terephthalate (PET), polylactic acid (PLA) or a combination thereof. Preferably, the bi-component binder fibre comprises polypropylene (PP) and polyethylene (PE). In another preferred embodiment, the bi-component binder fibre comprises fibres made of polyethylene terephthalate (PET) or recycled polyethylene terephthalate (PET).

In one embodiment, the bi-component binder fibre comprises recycled polypropylene (PP), recycled polyethylene (PE), recycled polyethylene terephthalate (PET), recycled polylactic acid (PLA) or a combination thereof.

In yet another embodiment, the bi-component binder fibre is an eccentric or concentric core/sheath fibre or an eccentric side-by-side type fibre.

In another embodiment, the sound absorbing material has a density of between 80 and 150 kg/m³, preferably between 90 to 130 kg/m³. This density range provides a sound absorbing material having satisfying sound absorbing properties.

In a further embodiment, the sound absorbing material has a thickness in the range of 5 to 60 mm, preferably in the range of 20 to 50 mm. This thickness range provides a sound absorbing material having satisfying sound absorbing properties, still not being too thick.

In yet another embodiment, the sound absorbing material has a thickness in the range of 25-50 mm and a density in the range of 80-130 kg/m³ or the sound absorbing material has a thickness in the range of 10-35 mm and a density in the range of 100-150 kg/m³. These combinations each provides a sound absorbing material having satisfying sound absorbing properties.

In a further embodiment, a thickness of the sound absorbing material is relative to a density of the sound absorbing material at a ratio of between

$$1 \frac{12}{13} : 10$$

and 6.25:10, such as 3.125:10 and

$$3 \frac{11}{13} : 10 ;$$

or at a ratio of between

$$\frac{2}{3} : 10$$

and 3.5:10, such as 1:10 and

$$2 \frac{1}{3} : 10.$$

These ratios provide a sound absorbing material having satisfying sound absorbing properties.

In one embodiment, the panel comprises at least a first layer of the sound absorbing material and further layer in the form of an air gap cavity. This is advantageous in that the air gap will provide further sound absorption to the panel. The panel comprising the layer of the sound absorbing material and an air gap cavity will have an increased thickness, however, the density of the sound absorbing material need not be adjusted as much as if no air gap was provided. Even though such a panel has an increased thickness due to the air gap provided therein, it will still be light and cheap to manufacture.

In one embodiment, the acoustic panel comprises a first layer of the sound absorbing material and a second layer of the sound absorbing material. The first layer and second layer are sandwiched around a core made of a sound insulating material. This acoustic panel is beneficial since it exhibits both sound absorbing and sound isolating properties. The sound absorbing material absorbs sound, while the core provides the panel with sound isolating properties.

In another embodiment, the sound insulating material of the core has a thickness of between 5 and 10 mm, preferably 6 mm, and/or a density of 2-300 kg/m³. This provides the core with satisfying sound insulating properties.

In one embodiment, the first layer of the sound absorbing material and the second layer of the sound absorbing material each has a thickness of between 15 and 30 mm, most preferred about 20 mm. This provides the acoustic panel having a sandwich structure with satisfying sound absorbing properties, and prevents the sandwiched panel from being too thick and too heavy.

In yet another embodiment, the acoustic panel comprises a cover material arranged on an exterior side of the sound absorbing material. Preferably, the cover material is a fabric. This is beneficial since it may provide the panel with an aesthetic appearance.

In yet a further embodiment, the acoustic panel is: a panel configured to be attached to a wall or ceiling in a room, a room divider, a panel configured to be part of a door or wall, or a panel configured to be bent to fit onto or into a curved surface.

In a second aspect, there is provided a method for manufacturing an acoustic panel. The method comprises the steps of providing a first sheet of sound absorbing material comprising lignocellulosic fibres providing sound absorbing properties to the sound absorbing material, and a binder binding the lignocellulosic fibres together, wherein the binder is a bi-component binder fibre; and shaping the sound absorbing material into a piece of sound absorbing material having a desired shape and size, preferably said shaping being conducted by cutting or sawing the sound absorbing material with a knife or blade. The method further comprises an optional step of covering, at least partly, the piece of sound absorbing material with a cover material. This method is beneficial since it is simple and provides an acoustic panel according to the first aspect and the advantages associated with said panel.

In one embodiment, the method further comprises a step of providing a second sheet of sound absorbing material and a sheet of a sound insulating material, and arranging the sound insulating material as a core between the first and second sheets of sound absorbing material, whereby a sandwich structured acoustic panel is obtained. Such an acoustic panel formed is beneficial since it exhibits both sound absorbing and sound isolating properties. The sound absorbing material absorbs sound, while the core provides the panel with sound isolating properties.

In a third aspect, there is provided a sound absorbing material comprising lignocellulosic fibres providing sound absorbing properties to the sound absorbing material, and a binder binding the lignocellulosic fibres together, wherein the binder is a bi-component binder fibre. This material has the advantages presented above in relation to the acoustic panel.

Further advantageous features of the invention are elaborated in embodiments disclosed herein. In addition, advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 shows a cross-section of an acoustic panel according to the present invention;

FIG. 2 shows a cross-section of an acoustic panel according to another embodiment of the present invention;

FIG. 3a shows another exemplary embodiment of an upholstered comfort member;

FIG. 3b shows a flow chart for a method for manufacturing an upholstered comfort member;

FIG. 4 shows a flow chart for a method for manufacturing a sound absorbing Material; and

FIG. 5 shows a flow chart for a method of manufacturing an acoustic panel according to the present invention.

### DETAILED EMBODIMENTS

Hereinafter, certain embodiments will be described more fully with reference to the accompanying drawings. The invention may, however, be embodied in many different forms and should not be construed as limited to the embodiments set forth herein. Rather, these embodiments are provided by way of example so that this disclosure will be thorough and complete, and will fully convey the scope of the invention, such as it is defined in the appended claims, to those skilled in the art.

Within the field of sound reduction, one distinguishes between sound isolation and sound absorption.

Sound isolation is the term used for materials, which contain sound between areas or rooms. For instance, a door or room divider may be filled with a sound isolating material, preventing sound from being transferred between the rooms separated by the door or the areas divided by the room dividing panel. Sound isolating materials reflect sound waves at a high degree back in the same direction where they came from. Hence, sound isolating materials preserve sound and noise within the space where they are located, and therefore, the level of sound within that space is necessarily not reduced.

Sound absorbing materials on the other hand, reflect sound waves at a low degree. When a sound wave enters a porous sound absorbing material, the low amount of energy of the sound wave entering and passing through the sound absorbing material is transformed by friction into heat energy. Since the amount of heat energy is at such a low level, no heating effect of the sound absorbing material takes place but the noise is reduced. Therefore, sound absorbing materials reduce the level of sound and noise in the space where they are arranged. However, a sound absorbing material is not a very efficient sound isolating member, since sound waves can pass through such materials due to its low reflective degree.

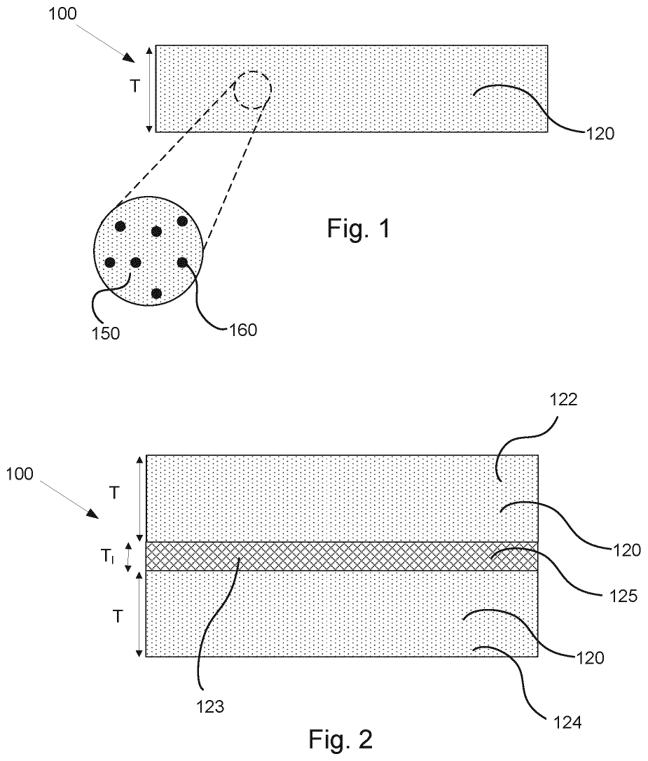

With reference to FIG. 1, an acoustic panel 100 is shown. The acoustic panel 100 comprises a sound absorbing material 120. The sound absorbing material 120 comprises fibres 150 and a binder 160. The fibres 150 provides sound absorbing properties to the acoustic panel 100 and the binder 160 binds the fibres 150 together and provides the acoustic panel 100 with resilient properties. Hence, the binder 160 provides the sound absorbing material 120 with flexibility, making it easy to shape the sound absorbing material 120 into a desired predetermined shape. Also, the flexibility makes the sound absorbing panel 100 bendable, allowing it to be used for curved applications.

The sound absorbing material 120 in the acoustic panel 100 has a thickness T being in the range of between 5 to 60 mm, preferably in the range of 20 to 50 mm.

The thickness T may vary within the specified range over an extension of the sound absorbing material 120.

FIG. 2 shows an acoustic panel 100 according to another embodiment of the invention. The acoustic panel 100 is formed as a layered sandwich structure, having a core 123 formed of a sound isolating material 125. The sound isolating core 123 is sandwiched between a first sound absorbing layer 122 and a second sound absorbing layer 124. The first and second sound absorbing layers 122, 124 are made of the sound absorbing material 120.

Preferably, the sound isolating material 125 is a porous sound isolating material 125, such that the sound isolating material 125 is semi-sound isolating. The fact that the sound isolating material 125 is porous provides an acoustic panel 100 where the sound waves may enter and pass through the sound isolating material 125, such that the first and second sound absorbing layers 122, 124 and the sound isolating core 123 may work as a unit, taking advantage of both the properties of the sound isolating material 125 and the sound absorbing material 120.

The acoustic panel 100 shown in FIG. 2 therefore exhibits both sound absorbing and sound isolating properties. The sound absorbing material 120 absorbs sound, while the core 123 provides the panel 100 with sound isolating properties. The sound isolating core 123 is preferably made of a porous wood fibre board. The sound isolating core 125 has a thickness T_{I} of 5-10 mm, most preferably about 6 mm. Further, the sound isolating core 125 has a density of between 2-300 kg/m³. The acoustic panel 100 shown in FIG. 2 is specifically beneficial when used as a room divider in for instance office spaces.

The first and second sound absorbing layers 122, 124 each have a thickness T. The thickness T of the first and second layers 122, 124 may be the same or have varying thickness.

In one preferred embodiment, the first layer 122 and the second layer 124 of the sound absorbing material 120 each has a thickness T of between 15 to 35 mm, most preferably about 20 mm, and the sound isolating core 125 has a thickness T_{I} of about 6 mm. Hence, the total thickness of such panel 100 is about 46 mm. Such panel has the same sound absorbing and isolating effect as a 100 mm thick panel known in the art.

Hence, in one embodiment of a sandwich acoustic panel 100, the first layer 122 of the sound absorbing material 120 has a thickness Tₐ₁ and the second layer 124 of the sound absorbing material 120 has a thickness Tₐ₂, and the core 123 has the thickness T_{I}, where Tₐ₁ and Tₐ₂ are different thicknesses. In said embodiment, the first layer 122 of the sound absorbing material 120 may have a density d1 and the second layer 124 of the sound absorbing material 120 may have a density d2. The density d1 may be the same or differ from the density d2. The core 123 has a density of between 2-300 kg/m³.

In another embodiment, the core 123 may be formed from the sound absorbing material 120 and the first and second layers 122, 124 are formed of the sound insulating material 125.

The sound isolating core 123 may be formed from a type of “wood fibre wool isolation”, which is compressed to obtain a material having a desired density to provide sufficient sound isolating properties.

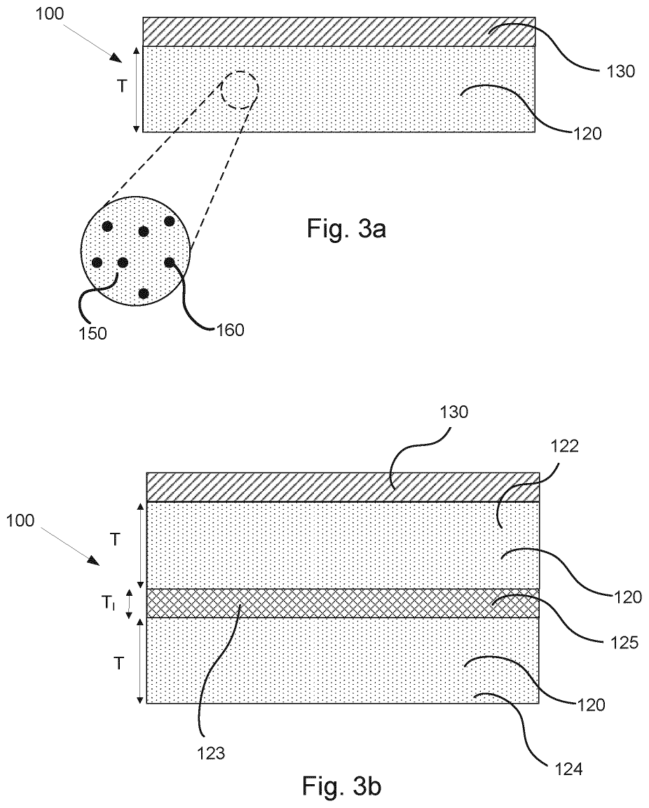

FIGS. 3a and 3b show acoustic panels 100 according to yet another embodiment, where the acoustic panels 100 as shown in FIGS. 1 and 2 comprise and optional cover material 130. The cover material 130 protects the sound absorbing material 120 and/or the sound isolating material 125. In addition, the cover material 130 may provide an aesthetic appearance to the acoustic panel 100.

The cover material 130 in FIGS. 3a and 3b cover an outer, exterior surface of the acoustic panels 100. However, the cover material 130 may also cover side edge surfaces and/or an internal surface configured to face i.e. a wall of a room.

The cover material 130 may be a fabric. The fabric may be a woven or non-woven fabric. The fabric may comprise fibres of cotton, hemp, linen and/or polyester.

The sound absorbing material 120 is slightly resilient and flexible such that its shape may be adapted to various dimensions. In addition, the sound absorbing material 120 is cuttable into any desired shape. The cutting can be performed using for instance a knife, a saw, a pair of scissors or any other suitable cutting utensil. Hence, the sound absorbing material 120 may be manufactured as a large web and subsequently be divided into any shape wanted. This facilitates the manufacturing method, making it efficient and cost-effective.

The sound absorbing material 120 comprises cellulosic fibres, such as lignocellulosic fibres 150, which preferably are wood fibres (such as Spruce wood fibres, Pinewood fibres, Aspen wood fibres, or Birch wood fibres). Alternatively, the lignocellulosic fibres 150 are plant fibres, such as baste fibres, e.g. hemp, jute, or flax, or fruit fibres, e.g. coconut fibres, pulp fibres, such as paper fibres, or fibres from recycled particle boards.

The wood, hemp or coconut fibres are preferable since they are easy to recycle and thus environmentally friendly. The wood fibres may be harvested from young trees, which have different properties than the timber of older trees. This is also advantageous for the environment, since there is a large portion of young forest which is not made use of. Instead, the material of the young forest is simply burnt after clearing of the young forest area.

Moreover, hemp and coconut fibres are abundant and have a reasonable pricing such that the production of the sound absorbing material 120 becomes cost effective.

Optionally, the sound absorbing material 120 originates from a thicker slab of cellulosic material (not shown) having a thickness of for instance 45 mm or 200 mm to form a slab of the sound absorbing material 120 of the thickness T.

The sound absorbing material 120 may have a density of between 80 and 150 kg/m³, and most preferred about 90 to 130 kg/m³. The density range provides a sound absorbing material 120 having satisfying sound absorbing properties.

Preferably, if the sound absorbing material 120 has a thickness T in the lower part of the range 20-50 mm, the sound absorbing material 120 preferably has a density in the upper part of the range 80 and 150 kg/m³. Both the thickness T and the density affect the sound absorbing properties of the sound absorbing material 120. The thickness T is generally relative to the density. However, this may change depending on the application and use of the sound absorbing material 120. For instance, if used in an acoustic panel 100 configured to be arranged as a wall hanged panel having an air gap behind, the presence of the air gap alter the ratio between the thickness T and density. Further, the air gap will provide further sound absorption to the panel 100. Hence, the panel 100 may comprise a layer of sound absorbing material 120 and an air gap provided in a cavity either between the panel 100 and for instance a wall, or a cavity being part of the panel 100 filled with air. The panel 100 comprising the layer of the sound absorbing material 120 and an air gap cavity will have an increased thickness, however, the density of the sound absorbing material 120 need not be adjusted as much as if no air gap was provided. Even though such a panel 100 has an increased thickness due to the air gap provided therein, it will still be light and cheap to manufacture.

The air gap described may also be arranged in relation to the sandwich structured panel 100 shown in FIG. 2.

Preferably, the sound absorbing material 120 has a density of 90 to 130 kg/m³ and a thickness T of 20 to 50 mm.

In one embodiment, the sound absorbing material 120 has the thickness T in the range of 25-50 mm and a density in the range of 80-130 kg/m³. Alternatively, the sound absorbing material 120 has the thickness T in the range of 10-35 mm and a density in the range of 100-150 kg/m³. Hence, a ratio between the thickness T and the density is preferably a ratio of between

$$1 \frac{12}{13} : 10$$

and 6.25:10, such as 3.125:10 and

$$3 \frac{11}{13} : 10 ;$$

or at a ration of between

$$\frac{2}{3} : 10$$

and 3.5:10, such as 1:10 and

$$2 \frac{1}{3} : 10.$$

The lignocellulosic fibres 150 have a length L. Preferably, the length L of the lignocellulosic fibres 150 is within the range of 1 to 50 mm, such as between 1 to 25 mm.

In one embodiment, at least 95%, such as at least 97%, of the lignocellulosic fibres 150 based by weight have a length L in the range of 1 to 25 mm. The remaining 5% or 3% may comprise dust like fibre residues having a length L shorter than 1 mm, or lignocellulosic fibres 150 having a length L longer than 25 mm.

The majority of the wood fibres may have a length L up to 50 mm, such as a length L in the range of about 1 to 25 mm. The length may have impact on how soft or rigid the fibre is experienced and how durable the fibre is. This in turn affect the sound absorbing properties of the sound absorbing material 120.

Further, the lignocellulosic fibres 150 may have a mean fibre size with a mean length L_{M} of 2 to 10 mm, preferably a mean length L_{M} of 2.5 to 6 mm, and a mean width W_{M} of 0.07 to 0.7 mm, preferably a mean width W_{M} of 0.1 to 0.4 mm; for example with a mean length L_{M} of 3.15 mm, and a mean width W_{M} of 0.15 mm. The mean length L_{M} and the mean width W_{M} are based on the number of lignocellulosic fibres 150 in the sound absorbing material 120.

A metal wire cloth sieve of a specific width (i.e. between 1 and 25 mm) may be used to determine the size of the lignocellulosic fibres 150, such that for instance 95% of the lignocellulosic fibres 150 based on weight pass through the width of the sieve and thus have a size smaller than the width of the sieve. Applicable standards are to ISO 3310-1:2016 and ISO 2591-1:1988.

According to an embodiment, at least 95% of the wood fibres based on weight passes through a metal wire cloth sieve width of 25 mm, according to ISO 3310-1:2016 and ISO 2591-1:1988. Further, not more than 5 wt. %, such as not more than 10 wt. % of the wood fibres passes through a metal wire cloth sieve width of 6 mm, according to ISO 3310-1:2016 and ISO 2591-1:1988

In one embodiment, the lignocellulosic fibres 150 have a length L of 15 mm or less. Optionally, between 10% and 90% of the total number of lignocellulosic fibres 150 have a length L between 1 and 10 mm. These ranges and dimensions of the lignocellulosic fibres 150 have proven specifically suitable for the sound absorbing properties of the sound absorbing material 120.

Additionally, the sound absorbing material 120 comprises the binder 160. The binder 160 serves to bind the lignocellulosic fibres 150 together and to provide a sound absorbing material 120 comprising a lower amount of non-sustainable materials compared to known sound absorbing materials. In addition, the binder 160, by binding the fibres 150 together, provides the sound absorbing material 120 with resilient properties, such that it reverts to its initial shape rather than being deformed if an applied pressure is removed.

Preferably, the binder is a binder fibre. According to a less preferred embodiment, the binder is a resin or a particulate thermoplastic. Though a resin may be used in providing a sound absorbing material 120, it provides a less flexible and less sound absorbing material. Similar disadvantages apply to a particulate thermoplastic.

A binder fibre is preferred, as less binder is required to provide the sound absorbing material 120. A single binder fibre may bind to several lignocellulosic fibres 150 of the sound absorbing material 120. In addition, the active surface area per volume unit is much higher for a fibre compared to a particle.

The binder 160 may be a thermoplastic binder selected from the group consisting of particulate polypropylene (PP), particulate polyethylene (PE), a bi-component binder fibre (bico binder fibre), or a combination thereof. The bico binder fibre represents a preferred binder.

The bico binder fibre may be a core/sheath fibre or a side-by-side type fibre. Preferably, the bico binder fibre is a centric fibre. Optionally, the binder fibre is core/sheath fibre. Further, the bico binder fibre may be hollow. A bico binder fibre may for instance be a core/sheath fibre comprising a core formed from PP and comprise an outer sheath of PE embedding the core of PP. The core of a bico binder fibre has a higher melting point than the melting point of the outer coating.

The bico binder fibre may comprise polypropylene (PP), polyethylene (PE), polyethylene terephthalate (PET), polylactic acid (PLA) or a combination thereof. Additionally or alternatively, the bico binder fibre may comprise recycled polypropylene (PP), recycled polyethylene (PE), recycled polyethylene terephthalate (PET), recycled polylactic acid (PLA) or a combination thereof. Further, the bico binder fibre may comprise a combination of recycled and non recycled PP, PE, PET and/or PLA. An advantage with using PET is that PET is abundantly available as a recycled PET fibre. Hence, the use of a bico binder fibre comprising PET is environmentally friendly as recycled PET may be used. Since recycled PET is abundant, it is also cheap. Preferably, the bico cinder fibre is a centric fibre comprising PP, PE, PET, PLA or a combination thereof.

According to an embodiment, the bico fibre has a linear density in the range 0.5 to 5 dtex, such as in the range 1 to 3 dtex, such as in the range 1 to 2.2 dtex. The linear density may be about 1.3 dtex. Further, the bico fibre may be a staple fibre. Such a staple fibre may be 3-24 mm, or more preferred 3 to 12 mm long, such as 5 to 8 mm long. The bico fibre may be about 6 mm long.

Further, the binder fibre may be a crimped fibre. Thus, the binder fibre may be an eccentric bico fibre. An eccentric bico fibre is soft and fluffy, and therefore aid in providing volume to the sound absorbing material 120.

A combination of different binder fibres may also be used. In addition to bico binder fibre, a staple fibre, such as bico staple fibre, may be added to adjust the properties of the obtained sound absorbing material 120.

When a bico binder is used as the binder 160, the bico fibre will bind the lignocellulosic fibres 150 together during the thermal formation process. If the sound absorbing material 120 is further processed with heat, the inner core may also melt and contribute to maintaining the obtained desired shape. If the sound absorbing material 120 is not further heat treated, the inner core may provide to additional flexibility and/or solidity, depending on the materials used.

The concentration of the binder 160 in the sound absorbing material 120 is in the range of between 1 and 30 wt %, preferably between 2 and 20 wt %, such as between 3 and 15 wt %. By using a bico binder fibre a lower amount of binder may be used.

A size of the binder fibre is preferably in the range and close to the size of the lignocellulosic fibres 150 to achieve a satisfactory sound absorbing material 120. An advantage with binder fibres 160 having a small particle size is that a higher number of binder fibres 160 may be used, which results in more binding sites between cellulosic fibres in the sound absorbing material 120. The size of the binder fibre, such as a bico binder fibre, is preferably in the range of 1-3 dtex, or even 1 to 2.2 dtex and most preferably in the range of 1.1 to 1.7 dtex. According to a preferred embodiment, the binder fibre has a size of 1.3 dtex. The binder fibre length is preferably in the range of 3 to 24 mm and most preferably in the range of 3 to 12 mm, or even more preferred 5-8 mm. Preferably, the binder fibre length is 6 mm. According to one preferred embodiment, the binder fibre has a size of 1.3 dtex and a length of 6 mm.

According to an embodiment, about 70 to 99 wt %, preferably about 76 to 98 wt %, most preferred about 80 to 97 wt %, of the sound absorbing material 120 is comprised of wood fibres which is a sustainable and recyclable material. Hence, the sound absorbing material 120 is much more environmentally friendly than e.g. other synthetic polymer foams used in the art as sound dampening materials. Moreover, the sound absorbing material 120 may take advantage and be formed from left over materials from e.g. sawmills.

Further, the wood fibres in the sound absorbing material 120 are bio-based and have hygroscopic properties. Thus, wood fibres having sufficient breathability, i.e. water vapour permeability, lead moisture, e.g. transpiration, away. Hence, the sound absorbing material 120 can improve the room climate.

The low concentration of the binder 160 allows for a sound absorbing material 120 comprising less plastic elements, or other non-sustainable adhesives such as cement based adhesives and the like. Hence, the sound absorbing material 120 and thus the acoustic panel 100 is therefore more environmentally friendly and easier to recycle.

Preferably, the sound absorbing material 120 comprises a flame retardant. The flame retardant may be a commercially available flame retardant, such as an organic or inorganic compound comprising sulphur, bromine, chlorine, phosphorous, nitrogen, aluminium and/or magnesium; a metal compound; a mineral; and/or a bromine and/or an ammonium or carboxylic salt; or a combination thereof. The flame retardant may be for instance ammonium sulphate. For instance, the sound absorbing material 120 may be treated with a flame retardant by spraying, soaking or impregnation it with a flame retardant dissolved or dispersed in a liquid. The sound absorbing material 120 may also comprise flame retardant fibres. Flame retardant fibres are known in the art (cf. e.g. WO 2017/084721 A1).

Hence, the sound absorbing material 120 disclosed herein comprises lignocellulosic fibres 150 providing sound absorbing properties to the sound absorbing material 120, and a binder 160 in the form of a bico binder 160. Preferably, the binder 160 is present at a concentration of between 1 and 30 wt %, such as between preferably 2 and 20 wt %, such as between 3 and 15 wt %.

The binder 160 binds the lignocellulosic fibres 150 together. Moreover, the binder 160 also contribute to making the sound absorbing material 120 more environmentally friendly, since less plastic material and no cement type adhesives are needed. The bico binder fibre may be an eccentric or concentric core-sheath binder fibre or an eccentric side-by-side binder fibre. Optionally, the bico binder fibre is crimped. The lignocellulosic fibres 150 may be wood fibres, such as wood fibres from Spruce, Pinewood, Aspen, or Birch and the fibres may have a length L in the range of about 1-25 mm.

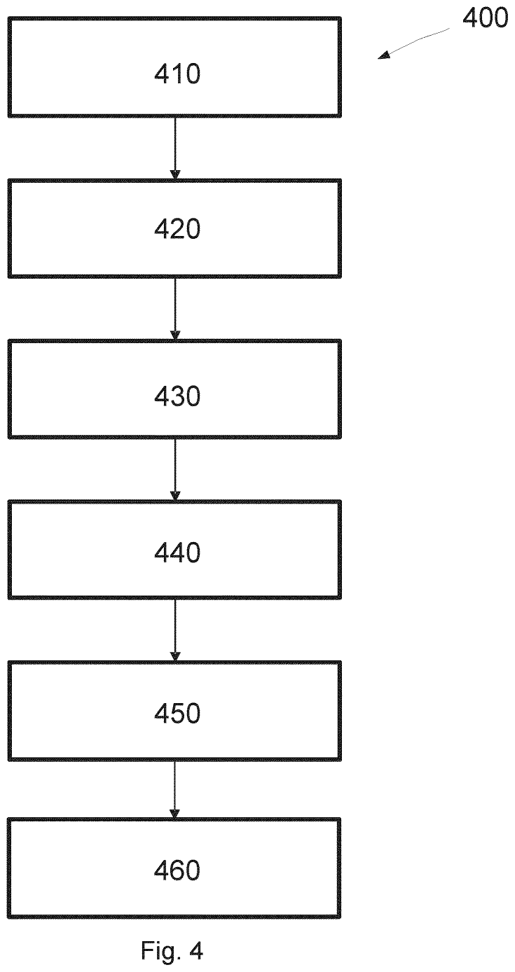

With reference to FIG. 4, a method for manufacturing the sound absorbing material 120 is shown. The method 400 comprises the steps of determining 410 the concentration of the binder 160 in relation to the lignocellulosic fibre 150; and mixing 420 the desired amount of lignocellulosic fibres 150 and the binder 160 such that a mixture of lignocellulosic fibres 150 and binder 160 is obtained. Then, the method 400 comprises placing 430 the mixture on a transport device and transporting 440 the mixture through a roller into an oven. Further, the method 400 comprises subjecting 450 the mixture to heat in the oven such that the binder 160 partly melts and binds the lignocellulosic fibres 150 together; and extracting 460 the formed sound absorbing material 120 from the oven.

Optionally, the step of mixing 420 the desired amount of lignocellulosic fibres 150 and the binder 160 is conducted in an aerated drum in a plurality of sequences.

Further, the step of subjecting 450 the mixture to heat may further comprise adjusting the height of the mixture soon to be the sound absorbing material 120 with rollers in the oven.

Finally, the method 400 may further comprise a step of cutting the formed sound absorbing material 120 into predetermined shapes, lengths and/or sheets.

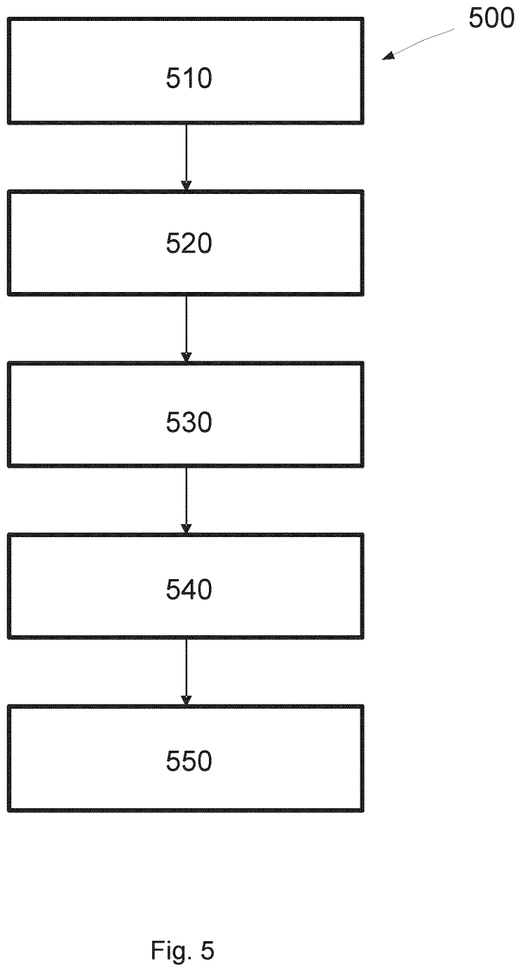

With reference to FIG. 5, a flow chart for manufacturing of an acoustic panel 100 is shown. The method 500 comprises the steps of providing 510 a first sheet of sound absorbing material 120 comprising lignocellulosic fibres 150 providing sound absorbing properties to the sound absorbing material 120, and a binder 160 binding the lignocellulosic fibres 150 together. The binder 160 is a bi-component binder fibre. The method 500 further comprises shaping 520 the provided sound absorbing material 120 into a desired shape and size. The shaping 520 may be conducted by cutting or sawing the sound absorbing material 120 with a knife or blade. Then, the method 500 comprises an optional step of covering 560, at least partly, the piece of sound absorbing material 120 with a cover material 130.

The method may further comprise an optional step of providing 530 a second sheet of sound absorbing material 120 and a sheet of a sound insulating material 125, and arranging 540 the sound isolating material 125 as a core 123 sandwiched between the first and second sheets of sound absorbing material 120. In this way, an acoustic panel is formed having a first layer 122 of the sound absorbing material 120 and a second layer 124 of the sound absorbing material 120 arranged on each surface of the core 123 of sound isolating material 125. Preferably, the layers 122, 124 of sound absorbing material 120 are attached to the sheet of sound isolating material 125 with an adhesive, such as a glue.

Alternatively, the step 530 comprises providing a sheet of a sound insulating material 125, and arranging 540 the sound isolating material 125 on one side of the sheet of sound absorbing material 120, to form an acoustic panel 100 having two layers (not shown).

The layered acoustic panels comprising both the sound isolating material 125 and the sound absorbing material 120 may also be formed as a continuous web of layered material, which is subsequently shaped 520 into any desired shape.

Optionally, the method 500 further comprises a step of covering 550, at least partly, the piece of sound absorbing material 120 with a cover material 130, to form an acoustic panel 100 as shown also in FIG. 3a or 3b. Alternatively, the cover material 130 may also cover exterior side surfaces of the acoustic panel 100 or enclose the complete acoustic panel 100 (not shown).

Test results have indicated that the sound absorbing material 120 having the properties as described herein can reduce sound at an efficient level. The sound absorbing material 120 achieves sound absorption at at least the same level as well known sound absorbing materials known in the art. However, the sound absorbing material 120 is more environmentally friendly than known sound absorbing materials.

Further, the embodiments shown in FIGS. 1, 2, 3a, and 3b may each comprise a cavity (not shown in the Figures), preferably filled with air. The cavity forms an air gap in the panel 100. Preferably, said cavity is arranged on a rear side of the panel 100 facing e.g. a wall onto which the panel 100 is configured to be hanged. The cavity forms an air gap between the sound absorbing material 120 and the surface onto which the panel 100 is to be attached. The panel 100 comprising at least one layer of the sound absorbing material 120 and a cavity forming an air gap will have an increased thickness. However, the density of the sound absorbing material 120 need not be adjusted as much as if no air gap was provided. Even though a panel 100 provided with the cavity forming the air gap has an increased thickness due to the cavity therein, it will still be light and cheap to manufacture.

Additionally or alternatively, the embodiments shown in FIGS. 2, and 3b each comprises a cavity (not shown in the Figures) filled with air being arranged between the sound absorbing material 120 and the sound insulating material 125.

Additionally or alternatively, the embodiments shown in FIGS. 3a and 3b each comprises a cavity (not shown in the Figures) filled with air being arranged between the sound absorbing material 120 and the cover material 130.

Additionally or alternatively, the panel 100 has a thickness being thicker along at least a part of a circumference of the panel 100, such that an air gap is formed between a thinner centre of the panel 100 and a surface onto which the panel 100 is attached.

Additionally or alternatively, the panel 100 has a thickness being thicker along at least a part of a circumference of the panel 100. The thicker circumference of the panel 100 may be connected to a bracket or profile (preferably a metallic L-shaped profile) in turn attached to the surface onto which the panel 100 is attached, whereby an air gap is formed between the panel 100 and the surface onto which the panel 100 is attached. Preferably, the panel 100 comprises a slit in the thickened circumference of the sound absorbing material 120. Said slit is configured to hold the bracket or profile used to attached the panel 100 to the surface onto which the panel 100 is to be connected.

The panels 100 of the embodiments disclosed herein may all be configured to be attached to a wall or ceiling. For instance, the panels 100 may be attached using a fastening means such as a screw, nail, bolt or the like. Alternatively or additionally, the panels 100 disclosed herein may comprise a loop or other fastening device which may be hung onto a pin, nail, screw or the like attached to a wall or ceiling. Alternatively or additionally, the panel 100 may be attached to a wall or ceiling by an adhesive.

Alternatively or additionally, the panels 100 according to the present invention are used as freestanding screens either standing on the floor and/or being attached to desks, to serve as desk dividers.

The scale of the different layers shown in the Figures are not accurate.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

1. An acoustic panel, comprising:
a sound absorbing material,
wherein the sound absorbing material comprises lignocellulosic fibres providing sound absorbing properties to the sound absorbing material, and a binder binding the lignocellulosic fibres together, wherein the binder is a bi-component binder fibre.

2. The acoustic panel according to claim 1, wherein the lignocellulosic fibres are wood fibres.

3. The acoustic panel according to claim 1, wherein the lignocellulosic fibres have a length between 1 and 25 mm.

4. The acoustic panel according to claim 1, wherein the binder is present at a concentration between 1 to 30 wt %, and/or wherein the binder fibres have a length in a range of 3-24 mm, and/or wherein the binder fibres have a thickness of 1-3 dtex.

5. The acoustic panel according to claim 1, wherein the bi-component binder fibre comprises polypropylene (PP), polyethylene (PE), polyethylene terephthalate (PET), polylactic acid (PLA) or a combination thereof.

6. The acoustic panel according to claim 1, wherein the bi-component binder fibre is an eccentric or concentric core/sheath fibre or an eccentric side-by-side type fibre.

7. The acoustic panel according to claim 1, wherein the sound absorbing material has a density of between 80 and 150 kg/m³.

8. The acoustic panel according to claim 1, wherein the sound absorbing material has a thickness (T) in a range of 5 to 60 mm.

9. The acoustic panel according to claim 1, wherein the sound absorbing material has a thickness (T) in a range of 25-50 mm and a density in a range of 80-130 kg/m³ or wherein the sound absorbing material has a thickness (T) in a range of 10-35 mm and a density in a range of 100-150 kg/m³.

10. The acoustic panel according to claim 1, wherein a thickness (T) of the sound absorbing material is relative to a density of the sound absorbing material at a ratio of between
$$1 \frac{12}{13} : 10$$
and 6.25:10; or at a ratio of between
$$\frac{2}{3} : 10$$
and 3.5:10.

11. The acoustic panel according to claim 1, wherein the panel comprises at least a first layer of the sound absorbing material and an air gap cavity.

12. The acoustic panel according to claim 1, wherein the acoustic panel comprises a first layer of the sound absorbing material and a second layer of the sound absorbing material, wherein said first layer and said second layer are sandwiched around a core made of a sound insulating material.

13. The acoustic panel according to claim 12, wherein the sound insulating material of the core has a thickness (T_{I}) of between 5 and 10 mm, and/or a density of 2-300 kg/m³.

14. The acoustic panel according to claim 13, wherein the first layer of the sound absorbing material and the second layer of the sound absorbing material each has a thickness (T₁, T₂) of between 15 and 30 mm.

15. The acoustic panel according to claim 1, wherein the acoustic panel comprises a cover material arranged on an exterior side of the sound absorbing material.

16. The acoustic panel according to claim 1, wherein the acoustic panel is: a panel configured to be attached to a wall or ceiling in a room, a room divider, a panel configured to be part of a door or wall, or a panel configured to be bent to fit onto or into a curved surface.

17. A method for manufacturing an acoustic panel, wherein the method comprises the steps of:
providing a first sheet of sound absorbing material comprising lignocellulosic fibres providing sound absorbing properties to the sound absorbing material, and a binder binding the lignocellulosic fibres together, wherein the binder is a bi-component binder fibre;
shaping said sound absorbing material into a piece of sound absorbing material having a desired shape and size; and
optionally covering, at least partly, said piece of sound absorbing material with a cover material.

18. The method according to claim 17, wherein the method further comprises a step of providing a second sheet of sound absorbing material and a sheet of a sound insulating material, and arranging the sound insulating material as a core between the first sheet and the second sheet of sound absorbing material, whereby a sandwich structured acoustic panel is obtained.

19. A sound absorbing material comprising lignocellulosic fibres providing sound absorbing properties to the sound absorbing material, and a binder binding the lignocellulosic fibres together, wherein the binder is a bi-component binder fibre.

20. The method according to claim 17, wherein the shaping is conducted by cutting or sawing the sound absorbing material with a knife or blade.
